(19) United States
(12) Patent Application Publication
(10) Pub. No.: US 2025/0260542 A1
(43) Pub. Date: Aug. 14, 2025

(54) CODEBOOK-BASED TRANSMISSION OF SOUNDING REFERENCE SIGNALS

(71) Applicant: Apple Inc., Cupertino, CA (US)

(72) Inventors: Yushu Zhang, Beijing (CN); Dawei Zhang, Saratoga, CA (US); Haitong Sun, Cupertino, CA (US); Hong He, San Jose, CA (US); Huaning Niu, San Jose, CA (US); Seyed Ali Akbar Fakoorian, San Diego, CA (US); Sigen Ye, San Diego, CA (US); Wei Zeng, Saratoga, CA (US); Weidong Yang, San Diego, CA (US)

(73) Assignee: Apple Inc., Cupertino, CA (US)

(21) Appl. No.: 18/859,700

(22) PCT Filed: Apr. 4, 2023
(86) PCT No.: PCT/US2023/017404

§ 371 Date: Oct. 24, 2024

Related U.S. Application Data
(60) Provisional application No. 63/336,188, filed on Apr. 28, 2022.

(51) Int. Cl. H04L 5/00

(52) U.S. Cl. CPC H04L 5/0053; H04L 5/0048

(57) ABSTRACT

The present application relates to devices and components including apparatus, systems, and methods to perform a codebook-based SRS transmission. In an example, eight or more antenna ports are used for the codebook-based SRS transmission. In this example, a UE can be configured by a base station for the codebook-based SRS transmission, whereby the configuration indicates a particular comb configuration, symbol index configuration, and/or cyclic shift configuration to allow the use of the eight or more antenna ports.

### CROSS-REFERENCES TO OTHER APPLICATIONS

This application claims priority to U.S. National Phase of PCT Application No. PCT/US2023/017404 filed Apr. 4, 2023, which claims priority to U.S. Provisional Application No. 63/336,188 filed on Apr. 28, 2022. Both applications are herein incorporated by reference in their entireties.

Cellular communications can be defined in various standards to enable communications between a user equipment and a cellular network. For example, Fifth Generation mobile network (5G) is a wireless standard that aims to improve upon data transmission speed, reliability, availability, and more.

### BRIEF DESCRIPTION OF THE DRAWINGS

FIG. 1 illustrates an example of a network environment, in accordance with some embodiments.

FIG. 2 illustrates an example of a codebook-based sounding reference signals (SRS) transmission, in accordance with some embodiments.

FIG. 3 illustrates an example of an operational flow/algorithmic structure for a user equipment (UE) using a codebook-based transmission of SRSs, in accordance with some embodiments.

FIG. 4 illustrates an example of an operational flow/algorithmic structure for a base station using a codebook-based transmission of SRSs, in accordance with some embodiments.

FIG. 5 illustrates an example of a configuration for a codebook-based transmission of SRSs using frequency division multiplexing, in accordance with some embodiments.

FIG. 6 illustrates another example of a configuration for a codebook-based transmission of SRSs using frequency division multiplexing, in accordance with some embodiments.

FIG. 7 illustrates an example of a configuration for a codebook-based transmission of SRSs using time division multiplexing, in accordance with some embodiments.

FIG. 8 illustrates another example of a configuration for a codebook-based transmission of SRSs using time division multiplexing, in accordance with some embodiments.

FIG. 9 illustrates an example of receive components, in accordance with some embodiments.

FIG. 10 illustrates an example of a UE, in accordance with some embodiments.

FIG. 11 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) can send sounding reference signals (SRSs) to a base station such that the base station can estimate an uplink channel quality and manage at least uplink communications from the UE. An SRS can be sent using a codebook-based transmission, whereby the UE receives information from the base station about precoding weights and uses these precoding weights for the SRS transmission. The SRS can be transmitted using multiple antenna ports (e.g., logical antenna ports referred to herein as SRS ports), where the base station configures the UE to use particular cyclic shifts and transmission combs, among other configuration parameters.

When eight SRS ports or a larger number of such ports is used challenges arise and relate to, for instance, using uniform cyclic shifts. To address such challenges, embodiments of the present disclosure involve using a particular comb configuration and/or a particular cyclic shift configuration that are associated with eight (or larger) SRS port transmissions. For instance, a transmission comb of two may be the only allowed transmission comb for use with an eight (or larger) SRS port transmission. Additionally or alternatively, cyclic shifts can be defined for an eight (or larger) SRS port transmission and can be associated with different transmission combs (e.g., transmission combs equal to two, four, and eight). Additionally or alternatively, comb offsets can be configured to support frequency division multiplexing (FDM) of SRS resources. Additionally or alternatively, symbol indexes can be configured to support division multiplexing (TDM). Additionally or alternatively, time domain orthogonal cover code (TD-OCC) can be used to support the SRS transmissions.

In the interest of clarity of explanation, SRS transmissions using eight SRS ports are described herein. However, the embodiments of the present disclosure are not limited as such and equivalently apply to a larger number of SRS ports (e.g., twelve, sixteen, etc.). Further, embodiments are described in connection with 5G networks. However, the embodiments are not limited as such and similarly apply to other types of communications networks including other types of cellular networks.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein refers to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

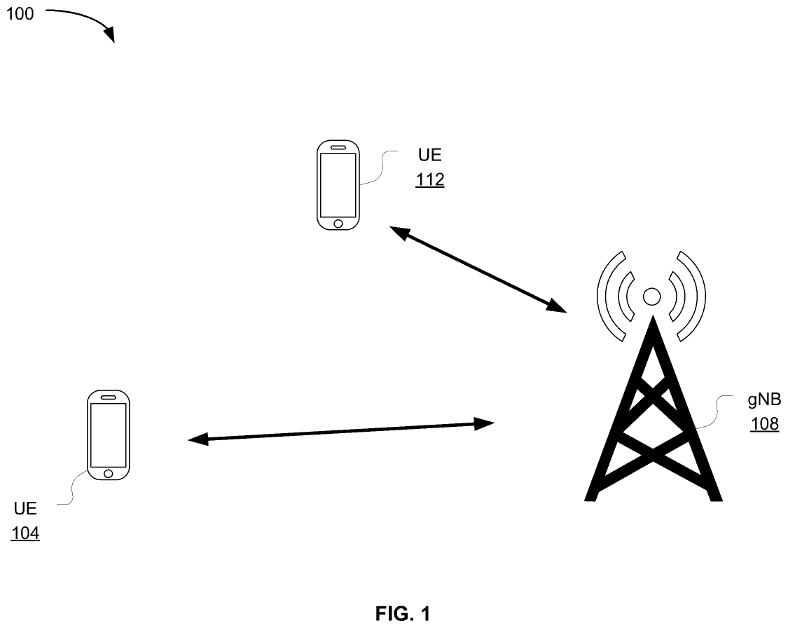

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards.

The gNB 108 may transmit information (for example, data and control signaling) in the downlink direction by mapping logical channels on the transport channels and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal block (SSB). The SSBs may be used by the UE 104 during a cell search procedure (including cell selection and reselection) and for beam selection.

The PDSCH may be used to transfer end-user application data, signaling radio bearer (SRB) messages, system information messages (other than, for example, MIB), and SIs.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel state information reference signals (CSI-RS). The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs (for example, six REGs).

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data), and can carry UCI.

Data transmission on PUSCH can be codebook-based, where the gNB 108 indicates precoding weights for the UE 104 to use. For the gNB 108 to determine the precoding weights, the gNB 108 may have previously configured the UE 104 to transmit SRS and may have triggered the UE 104 to do so. As illustrated in FIG. 1, the gNB 108 may communicate with multiple UEs (including the UE 104 and a UE 112). The gNB 108 may configure each of such UEs 104 and 112 to use particular SRS resource sets such that the gNB 108 can receive SRSs transmitted by the UEs 104 and 112 to then determine the precoding weights that each UE needs to use for its uplink data transmission.

The UE 104 and the gNB 108 may perform beam management operations to identify and maintain desired beams for transmission in the uplink and downlink directions.

The beam management may be applied to both PDSCH and PDCCH in the downlink direction, and PUSCH and PUCCH in the uplink direction.

In an example, communications with the gNB 108 and/or the base station can use channels in the frequency range 1 (FR1), frequency range 2 (FR2), and/or a higher frequency range (FRH). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

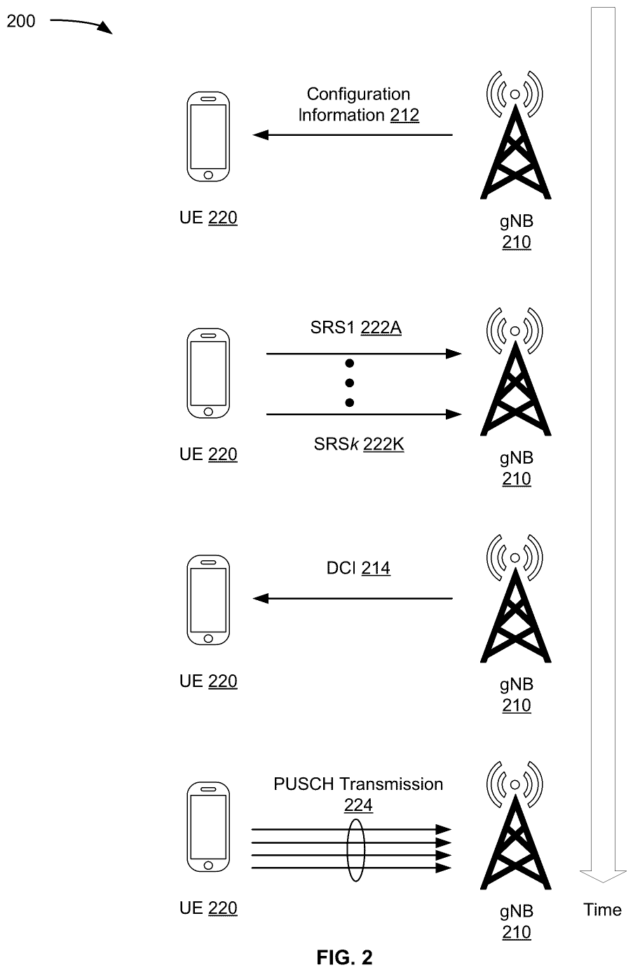

FIG. 2 illustrates an example of a codebook-based SRS transmission 200, in accordance with some embodiments. An SRS can be used for uplink channel state estimation, allowing channel quality estimation to enable uplink link adaptation and/or frequency-selective scheduling. In the context of an uplink multiple input multiple output (MIMO) system, the SRS can also be used to determine precoders and a number of layers that provide particular throughput and/or signal to interference plus noise ratio (SINR). The SRS can be transmitted to a gNB 210 (e.g., an example of the gNB 108) from a UE 220 (e.g., an example of the UE 104) using a codebook-based transmission.

A codebook-based transmission involves the UE 220 transmitting data on an uplink channel (e.g., PUSCH) using precoding weights that have been selected from a codebook. The gNB 210 indicates, to the UE 220 and on the downlink (e.g., on PDCCH), the precoding weights to use. Codebooks can be defined as matrices, where each matrix defines a set of precoding weights and can be referred to as a precoding matrix. The dimension of a precoding matrix depends on the number of layer and the number of antenna ports (e.g., referred to herein as SRS ports). The number of rows of the precoding matrix corresponds to the number of antenna ports, whereas the number of columns of the precoding matrix corresponds to the number of layers. This allows matrix multiplication between the precoding matrix and a column vector that includes the input symbols of each layer. Multiple codebooks (e.g., precoding matrices) can be defined to support a range of layers and a range of antenna ports. For example, the range of antenna ports can include at least eight antenna ports.

In the illustration of FIG. 2, prior to the selection of precoding weights, the gNB 210 configures the UE 220 to perform a codebook-based SRS transmission. For example, the gNB 210 sends configuration information 212 to the UE 220. This configuration information 212 can be sent based on UE capability information of the UE 220 indicating that the UE 220 supports codebook-based transmissions. The configuration information 212 indicates to the UE 220 that such transmissions are to be used. The configuration information 212 also configures the UE 220 to use an SRS resource set. This set can include an SRS resource if the UE 220 has a single antenna panel and two SRS resources if the UE 220 has two antenna panels. Each SRS resource is configured with a number of antenna ports (e.g., SRS ports) depending on the UE capability. When the UE 220 can support eight or more antenna ports, the SRS resource(s) can be configured with eight or more antenna ports.

Next, the UE 220 transmits SRS to the gNB 210 based on the configuration information 212. The SRS transmissions are illustrated as SRS1 222A through SRSk 222K to indicate that “k” antenna ports are used and can be responsive to a trigger of the gNB 210. For instance, the gNB 210 uses PDCCH to trigger an aperiodic transmission, a media access control (MAC) control element (CE) to activate semi-persistent SRS transmissions, or RRC signaling to configure periodic SRS transmissions. When at least eight antenna ports are configured for use, the UE 210 can send at least eight SRS resources (e.g., “k=8”) using the at least eight antenna ports.

Thereafter, the gNB 210 compares the SRS transmissions to select a set of antenna ports, an appropriate rank (e.g., the number of layers to be used), and a precoding matrix. For instance, the gNB 210 determines that the precoding matrix may maximize the rank and the received signal to noise ratio.

The gNB 210 then uses DCI 214 to allocate PUSCH resources. For instance, a DCI message having format 0_1 is used. This message includes SRS resource indicator (SRI) and a precoding information and number of layers field. The SRI indicates to the UE the number of antenna ports to use for the PUSCH transmission. The precoding information and number of layers field indicates the precoding matrix (e.g., in the form of a transmitted precoding matrix indicator (TPMI)) and the number of layers to use.

The UE 220 uses the allocated resources to transmit PUSCH traffic (illustrated a PUSCH transmission 224) and other signals (e.g., DMRS) using the indicated antenna ports, number of layers, and precoding matrix. In the illustration of FIG. 2, the PUSCH transmission uses four antenna ports (illustrated with the four arrows), where each corresponds to one of four layers and uses corresponding precoding weights from the precoding matrix.

An SRS resource can be allocated for an SRS transmission according to a number of steps, such as the steps defined in 3GPP TS 38.211, V16.8.0 (2022 January), section 6.4.1.4, the content of which is hereby incorporated by reference in its entirety. One step includes the generation of a base sequence r^{p}^{ᵢ}(n, l′)=r_{u,v}^{α}^{ᵢ}^{,δ}(n), where n=0, 1, 2, . . . . M_{sc,b}^{SRS}−1, l′ is the symbol index, r_{u,v}^{α}^{ᵢ}^{,δ}(n) is defined in section 5.2.2 of 3GPP TS 38.211, αᵢ=2πn_{SRS}^{cs,i}/N_{SRS}^{cs,max} is n_{SRS}^{cs,i} is the cyclic shift for antenna port i, which is determined by the cyclic shift configured by RRC signaling and the port index i. The maximum number of cyclic shift n_{SRS}^{cs,max} is determined by the number of comb configured by transmission comb (K_{TC}) and this association is defined in Table 6.4.1.4.2-1, copied herein below as Table 1.

TABLE 1

| K_{TC} | n_{SRS}^{cs, max} |
|---|---|
| 2 | 8 |
| 4 | 12 |
| 8 | 6 |

Another step involves resource mapping. In particular, the sequence r^{p}^{ᵢ}(n, l′) for each OFDM symbol l′ and for each of the antenna ports of the SRS resource is multiplied with the amplitude scaling factor β_{SRS} in order to conform to a particular transmit power and mapped in sequence starting with r^{p}^{ᵢ}(0, l′) r to resource elements (k, l) in a slot for each of the antenna ports pᵢ. This mapping allocates the SRS to different bandwidth (e.g., in the frequency domain) and symbols (e.g., in the time domain) based on a configured comb offset. The different antenna ports pᵢ can be differentiated by using different cyclic shifts. Generally, a uniform cyclic shift is used for an antenna port (e.g., a uniform distribution of the n_{SRS}^{cs,i} across the antenna ports pᵢ) to have a good separation between the antenna ports. Further instance, and referring back to Table 1, for a four-antenna port case, the second and fourth antenna ports may take different comb offset when the cyclic shift offset is configured to be larger than half the maximum cyclic shift compared to the first and third antenna ports. Additionally, frequency hopping can be enabled to transmit SRS in different symbols with different frequency domain location so that gNB 210 can get a wider bandwidth uplink channel, which in turn can improve the gNB's 210 estimation of the uplink channel.

Challenges arise when a codebook-based SRS transmission is to be performed using eight or more antenna ports. For instance, and referring back to Table 1, it may not be possible to create uniform cyclic shift for eight ports SRS when the transmission comb is equal to four or eight. Non-uniform cyclic shifts may be used, but these may degrade the overall performance because they may not result in a good separation between the antenna ports. More cyclic shifts may also be needed and these may necessitate additional resource elements for SRS to have a good separation.

Embodiments of the present disclosure can mitigate such challenges. In particular, the configuration information 212 indicates comb information and/or cyclic shift information specific for a codebook-based SRS transmission that uses eight or more antenna ports. In an example, the configuration information 212 indicates that a transmission comb of two may be the only allowed transmission comb for use with an eight (or larger) SRS port transmission. Referring back to Table 1, the first row corresponding to the transmission comb of two can be specified (e.g., in a technical specification) to be only applicable to the eight (or larger) SRS port transmission. In another example, cyclic shifts can be defined for an eight (or larger) SRS port transmission and can be associated with different transmission combs (e.g., transmission combs equal to two, four, and eight). For instance, a column can be added to Table 1, whereby n_{SRS}^{cs,max} equal to eight, twelve, and sixteen (or some other values that would result in a uniform distribution of cyclic shifts) correspond with the transmission combs of two, four, and eight and are associated with an eight SRS port transmission. In a further example, comb offsets can be configured to support frequency division multiplexing (FDM) of SRS resources that are to be transmitted. In yet another example, indexes used for the SRS symbols can be configured to support division multiplexing (TDM). In also another example, TD-OCCs can be used to support the SRS symbol transmissions. These examples can be used independently of each other or in conjunction with each other.

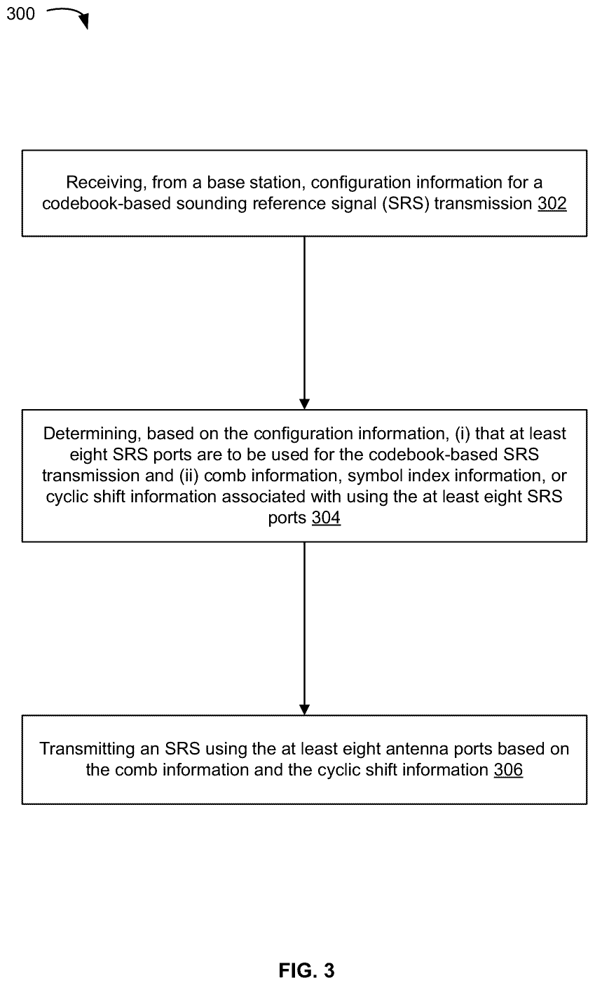

FIG. 3 illustrates an example of an operational flow/algorithmic structure 300 for UE using a codebook-based transmission of SRSs, in accordance with some embodiments. The UE is an example of the UE 104, the UE 220, or the UE 1000. Portions or the entirety of the operational flow/algorithmic structure 300 can be implemented as part of the SRS codebook-based SRS transmission 200.

In an example, the operational flow/algorithmic structure 300 may include, at 302, receiving, from a base station, configuration information for a codebook-based SRS transmission. For instance, the configuration information 212 is received via RRC signaling.

In an example, the operational flow/algorithmic structure 300 may include, at 304, determining, based on the configuration information, (i) that at least eight SRS ports are to be used for the codebook-based SRS transmission and (ii) comb information, symbol index information, or cyclic shift information associated with using the at least eight SRS ports. For instance, the configuration information 212 can indicate that the base station has configured the UE to transmit SRS across using all of its antenna ports, which may include eight or more antenna ports. The comb information can be associated with a requirement to use transmission comb two only for the SRS transmission. Alternatively, the comb information may indicate that transmission comb two, four, or eight is allowed. In this case, the cyclic shift information can be associated with a uniform cyclic shift to use for each antenna port depending on the transmission comb. When comb four or eight are configured for the UE, a comb offset can also be configured to allow using FDM for the SRS transmission. Additionally, the symbol index information can indicate symbol indexes to use TDM for the SRS transmission. The symbol index information and the cyclic shift information can indicate to use TD-OCCs for the SRS transmission.

In an example, the operational flow/algorithmic structure 300 may include, at 306, transmitting an SRS using the at least eight antenna ports based on the comb information and the cyclic shift information. For example, given the configured SRS resource sets, SRS resources are sent using the eight or more antenna ports. This use can include using the cyclic shifts when generating the relevant base sequence and/or mapping the resulting symbols to SRS resources per port based on the transmission comb, transmission comb offset, symbol indexes, and/or TD-OCCs.

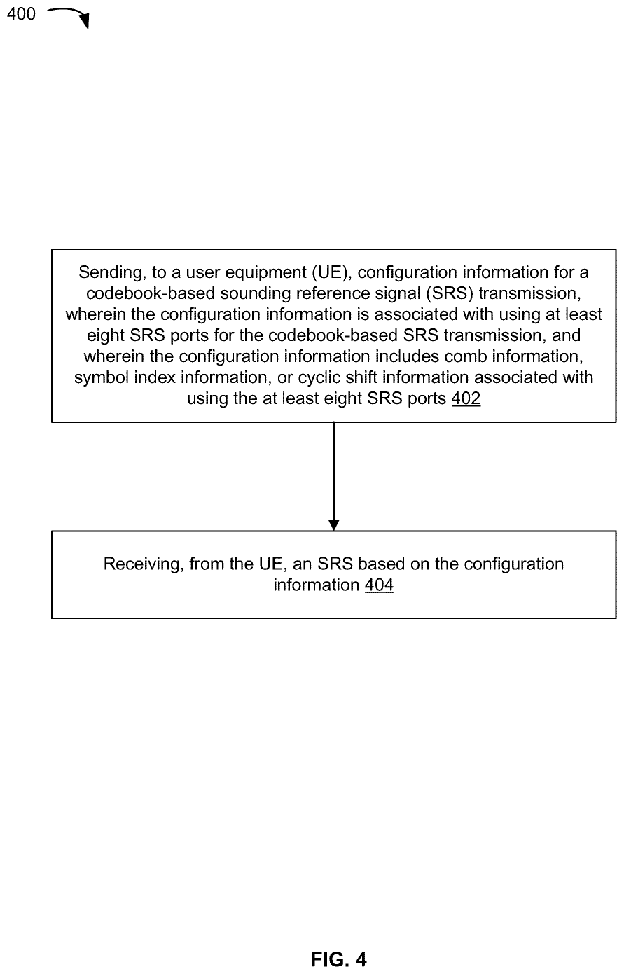

FIG. 4 illustrates an example of an operational flow/algorithmic structure 400 for a base station using a codebook-based transmission of SRSs, in accordance with some embodiments. The base station is an example of the gNB 108, the gNB 210, or the gNB 1100. Portions or the entirety of the operational flow/algorithmic structure 400 can be implemented as part of the SRS codebook-based SRS transmission 200.

In an example, the operational flow/algorithmic structure 400 may include, at 402, sending, to a user equipment (UE), configuration information for a codebook-based sounding reference signal (SRS) transmission, wherein the configuration information is associated with using at least eight SRS ports for the codebook-based SRS transmission, and wherein the configuration information includes comb information, symbol index information, or cyclic shift information associated with using the at least eight SRS ports. For instance, the configuration information 212 is sent via RRC signaling and indicates allocation of SRS resources on an uplink channel. The base station configures the UE to transmit SRS across using all of its antenna ports, which may include eight or more antenna ports. The comb information can be associated with a requirement to use transmission comb two only for the SRS transmission. Alternatively, the comb information may indicate that transmission comb two, four, or eight is allowed. In this case, the cyclic shift information can be associated with a uniform cyclic shift to use for each antenna port depending on the transmission comb. When comb four or eight are configured for the UE, a comb offset can also be configured to allow using FDM for the SRS transmission. Additionally, the symbol index information can indicate symbol indexes to use TDM for the SRS transmission. The symbol index information and the cyclic shift information can indicate to use TD-OCCs for the SRS transmission.

In an example, the operational flow/algorithmic structure 400 may include, at 404, receiving, from the UE, an SRS based on the configuration information. For instance, an SRS resource is received based on the configuration information 212 and corresponds to one of the SRS ports. Additional SRS resources can be similarly received, each corresponding to one of the antenna ports. Upon receiving the SRS resources, the base station can perform SRS measurements to then allocate PUSCH resources and determine the number of layers and precoding matrix that are to be used and inform the UE (e.g., via DCI) about such allocation and determination.

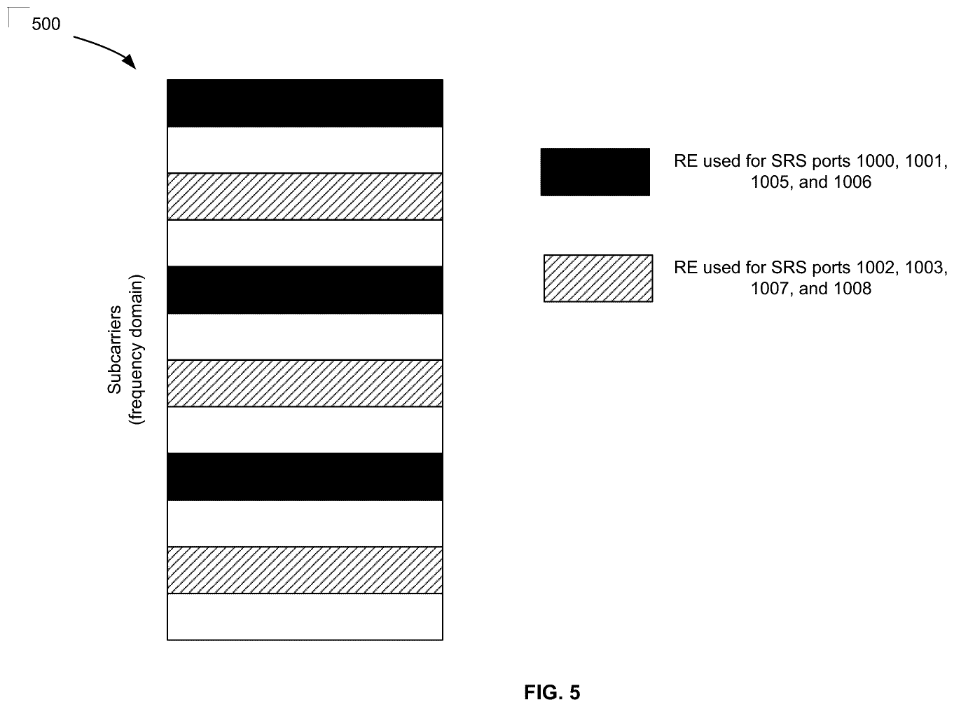

FIG. 5 illustrates an example of a configuration 500 for a codebook-based transmission of SRSs using FDM, in accordance with some embodiments. In this example, a transmission comb equal to two, four, and/or eight is allowed for an eight port SRS transmission. Some ports can be multiplexed in an FDM manner. Some of the antenna ports may be associated with different comb offsets, and such offsets can be applied to the transmission comb equal to four and/or eight only or to all transmission comb values. To do so, the eight antenna ports are associated with sets (e.g., each set including two or four antennas) and each set is associated with a comb offset for use in the transmission of the corresponding SRS resources. As such, the SRS resources of each set are transmitted based on the comb offset associated with the set. The SRS resources of two different sets are thereby multiplexed in an FDM manner.

In the example of FIG. 5, the eight antenna ports are organized in two sets: a first set of four antenna ports (e.g., SRS ports 1000, 1001, 1005, and 1006) and a second set of the four remaining antenna ports (e.g., SRS ports 1002, 1003, 1007, and 1008). A first comb offset having a value of one is configured for the first set. A second comb offset having a value of three is configured for the second set. Accordingly, SRS resources corresponding to the first set of antenna ports are shown as occupying, in the frequency domain, the second subcarrier starting from the bottom and repeating every four subcarriers. These SRS resources are shown with the diagonally dashed rectangles. In comparison, SRS resources corresponding to the second set of antenna ports are shown as occupying, in the frequency domain, the fourth subcarrier starting from the bottom and repeating every four subcarriers. These SRS resources are shown with the solid dark rectangles. Of course, different comb offsets are possible.

The comb offsets can be configured via RRC signaling. In an example, the comb offset for each set is indicated in the configuration information. In another example, in order to reduce the size of the configuration information, the first comb offset is indicated in the configuration information. The UE can determine the second comb offset based on the comb value (which can be indicated in the configuration information) and the first comb offset. For instance, the second comb offset is offset from the first comb offset by half the comb value (or some other predefined offsetting metric).

The grouping of the eight antenna ports into sets (e.g., which antenna ports can share the same comb offset) can be predefined. Additionally or alternatively, the grouping can be configured by higher layer signaling or determined by whether antenna ports share the same phase tracking reference signal (PT-RS) port or not. For instance, the base station can configure the grouping of the eight antenna ports. Or, given that four antenna ports share the same PT-RS port, the UE can determine that these antenna ports can be grouped together.

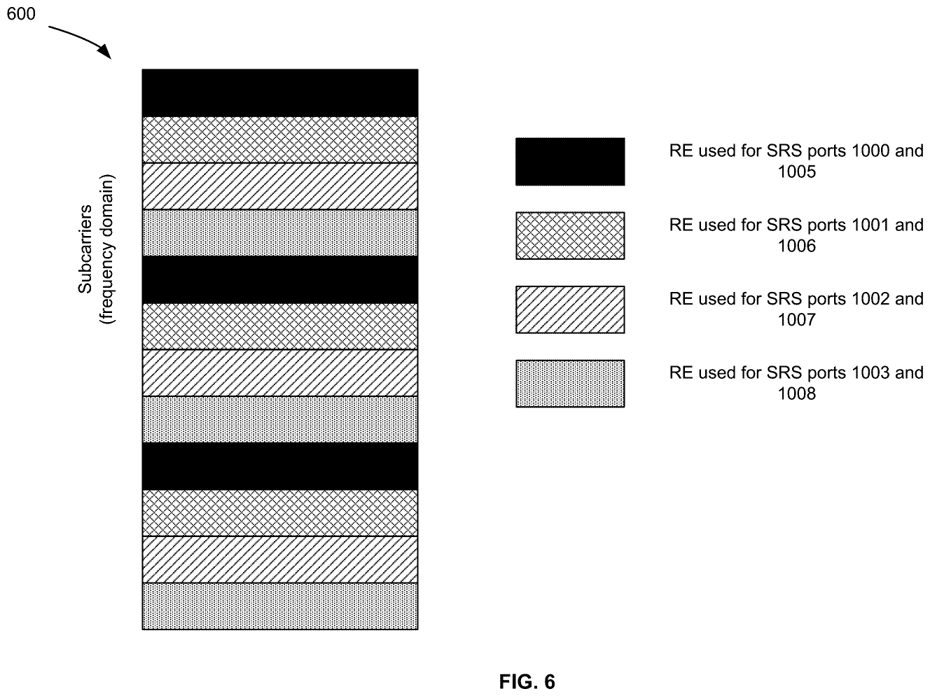

FIG. 6 illustrates another example of a configuration 600 for a codebook-based transmission of SRSs using FDM, in accordance with some embodiments. The configuration 600 is similar to the configuration 500, except that the eight antenna ports are grouped in four sets, each including two antenna ports. Similarities are not repeated herein (including the used signaling and the decision to group the antenna ports), but equivalently apply to the configuration 600.

In the example of FIG. 6, the eight antenna ports are organized in four sets: a first set of two antenna ports (e.g., SRS ports 1002 and 1007), a second set of the two antenna ports (e.g., SRS ports 1000 and 1005), a third set of two antenna ports (e.g., SRS ports 1001 and 1006), and fourth set of the two remaining antenna ports (e.g., SRS ports 1003 and 1008). A first comb offset having a value of one is configured for the first set. A second comb offset having a value of three is configured for the second set. A third comb offset having a value of five is configured for the third set. A fourth comb offset having a value of seven is configured for the fourth set. Accordingly, SRS resources corresponding to the first set of antenna ports are shown as occupying, in the frequency domain, the fourth subcarrier starting from the bottom and repeating every four subcarriers. These SRS resources are shown with the diagonally-dashed rectangles. In comparison, SRS resources corresponding to the second set of antenna ports are shown as occupying, in the frequency domain, the third subcarrier starting from the bottom and repeating every four subcarriers. These SRS resources are shown with the solid dark rectangles. SRS resources corresponding to the third set of antenna ports are shown as occupying, in the frequency domain, the second subcarrier starting from the bottom and repeating every four subcarriers. These SRS resources are shown with the cross-dashed rectangles. SRS resources corresponding to the fourth set of antenna ports are shown as occupying, in the frequency domain, the first subcarrier starting from the bottom and repeating every four subcarriers. These SRS resources are shown with the dotted rectangles. Of course, different comb offsets are possible.

The comb offsets can be configured via RRC signaling. In an example, the comb offset for each set is indicated in the configuration information. In another example, in order to reduce the size of the configuration information, the first comb offset is indicated in the configuration information. The UE can determine the comb offset of each remaining set based on the comb value (which can be indicated in the configuration information), the first comb offset, and an antenna port index.

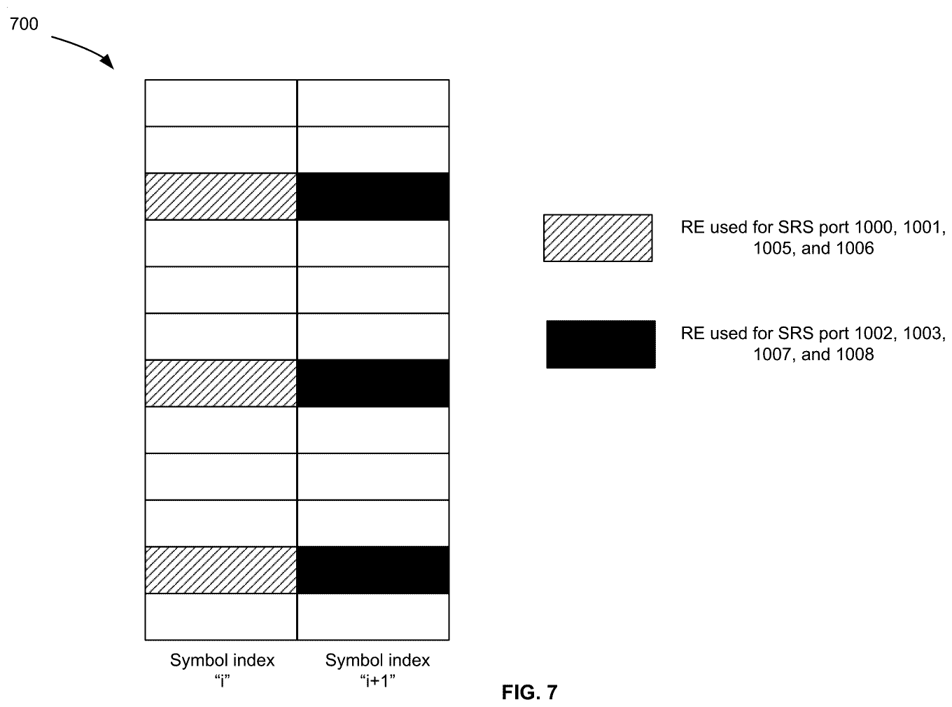

FIG. 7 illustrates an example of a configuration 700 for a codebook-based transmission of SRSs using TDM, in accordance with some embodiments. In this example, a transmission comb equal to two, four, and/or eight is allowed for an eight port SRS transmission. Some ports can be multiplexed in a TDM manner. Some of the antenna ports may be associated with different symbols used for the SRS transmission (e.g., OFDM symbols l′), and such symbols can be applied to the transmission comb equal to four and/or eight only or to all transmission comb values. To do so, the eight antenna ports are associated with sets (e.g., each set including two or four antennas) and each set is associated with a symbol index for use in the SRS transmission. As such, the symbols of each set are transmitted based on the symbol index associated with the set. The symbols of two different sets are thereby multiplexed in an TDM manner.

In the example of FIG. 7, the eight antenna ports are organized in two sets: a first set of four antenna ports (e.g., SRS ports 1000, 1001, 1005, and 1006) and a second set of the four remaining antenna ports (e.g., SRS ports 1002, 1003, 1007, and 1008). A first symbol index having a first value is configured for the first set (e.g., the four antenna ports of the first set may use the same symbol index). A second symbol index having a second value is configured for the second set (e.g., the four antenna ports of the second set may use the same symbol index, which may be different from the one used for the first set). Accordingly, SRS resources corresponding to the first set of antenna ports are shown as occupying, in the time domain, resources using the first symbol index “i.” These SRS resources are shown with the diagonally dashed rectangles. In comparison, SRS resources corresponding to the second set of antenna ports are shown as occupying, in the time domain, resources using the second symbol index “i+1.” These SRS resources are shown with the solid dark rectangles. Of course, different symbol indices are possible, and these indices need not be contiguous (e.g., symbol index “i” and symbol index “i+k,” where “k>1” can be used).

The symbol indices can be configured via RRC signaling. In an example, the symbol index for each set is indicated in the configuration information. In another example, in order to reduce the size of the configuration information, the first symbol index is indicated in the configuration information. The UE can determine the second symbol index based on the first symbol index and a predefined symbol offset (e.g., an offset of “k” where “k” is a positive integer greater or equal to one).

The grouping of the eight antenna ports into sets (e.g., which antenna ports can share the same symbol index) can be predefined. Additionally or alternatively, the grouping can be configured by higher layer signaling or determined by whether antenna ports share the same phase tracking reference signal (PT-RS) port or not. For instance, the base station can configure the grouping of the eight antenna ports. Or, given that four antenna ports share the same PT-RS port, the UE can determine that these antenna ports can be grouped together.

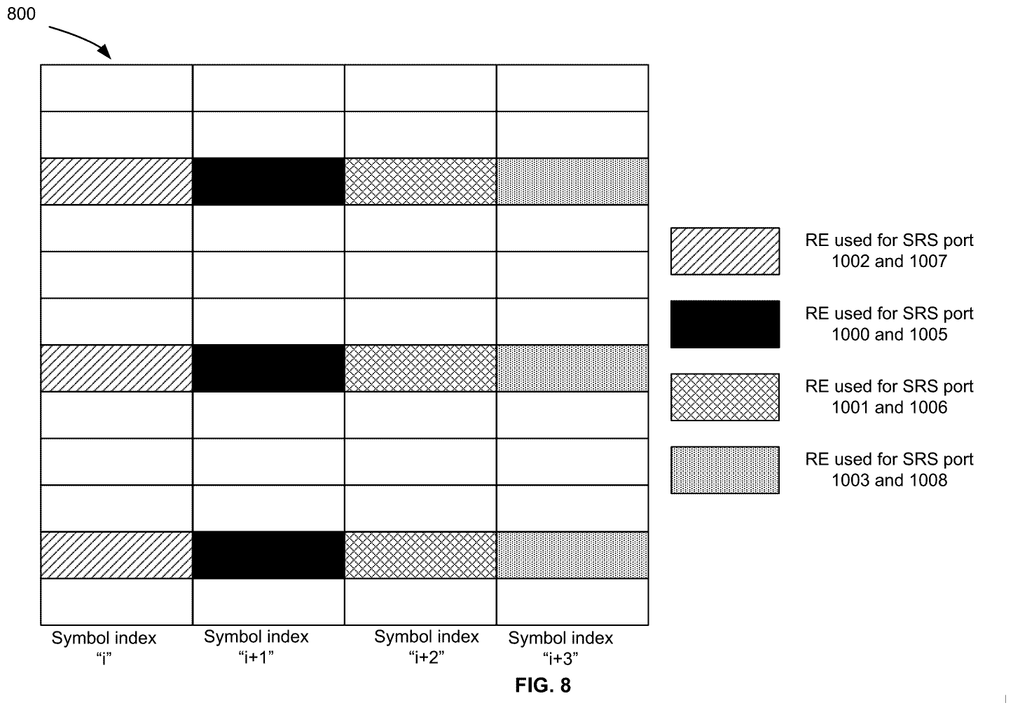

FIG. 8 illustrates another example of a configuration 800 for a codebook-based transmission of SRSs using TDM, in accordance with some embodiments. The configuration 800 is similar to the configuration 700, except that the eight antenna ports are grouped in four sets, each including two antenna ports. Similarities are not repeated herein (including the used signaling and the decision to group the antenna ports), but equivalently apply to the configuration 800.

In the example of FIG. 8, the eight antenna ports are organized in four sets: a first set of two antenna ports (e.g., SRS ports 1002 and 1007), a second set of the two antenna ports (e.g., SRS ports 1000 and 1005), a third set of two antenna ports (e.g., SRS ports 1001 and 1006), and a fourth set of the two remaining antenna ports (e.g., SRS ports 1003 and 1008). A first symbol index is configured for the first set. A second symbol index is configured for the second set. A third symbol index is configured for the third set. A fourth symbol index is configured for the fourth set. Accordingly, SRS resources corresponding to the first set of antenna ports are shown as occupying, in the time domain, resources using the first symbol index “i.” These SRS resources are shown with the diagonally-dashed rectangles. In comparison, SRS resources corresponding to the second set of antenna ports are shown as occupying, in the time domain, resources using the first symbol index “i+1.” These SRS resources are shown with the solid dark rectangles. SRS resources corresponding to the third set of antenna ports are shown as occupying, in the time domain, resources using the first symbol index “i+2.” These SRS resources are shown with the cross-dashed rectangles. SRS resources corresponding to the fourth set of antenna ports are shown as occupying, in the time domain, resources using the first symbol index “i+3.” These SRS resources are shown with the dotted rectangles. Of course, different symbol indices are possible, and these indices need not be contiguous (e.g., whereas symbol index “i” is used, the next used symbol index is “i+k,” where “k>1”).

In other examples, TD-OCCs can be used. In particular, the eight antenna ports can be distinguished by using a combination of a number “M” of TD-OCCs and a number “N” of cyclic shifts, where “M×N” is equal to eight. The “M” TD-OCCs can be applied as orthogonal cover codes to “M” symbols used for SRS transmission (e.g., OFDM symbols l′). Doing so allows the use of transmission comb equal to two, four, and/or eight for an eight port SRS transmission. In particular, the TD-OCCs can be applied to transmission comb equal to four and/or eight only or to all comb values.

In an example, two SRS symbols can be used for the eight SRS port transmission. Two TD-OCCs and four cyclic shifts can be used to distinguish the eight antenna ports. Table 2 below illustrates examples of usable TD-OCCs and cyclic shifts.

TABLE 2

| Port Index | Cyclic Shift | Orthogonal Cover Code |
|---|---|---|
| 1000 | n_cs | [1, 1] |
| 1001 | n_cs | [1, −1] |
| 1002 | (n_cs + 3) mod 12 | [1, 1] |
| 1003 | (n_cs + 3) mod 12 | [1, −1] |
| 1004 | (n_cs + 6) mod 12 | [1, 1] |
| 1005 | (n_cs + 6) mod 12 | [1, −1] |
| 1006 | (n_cs + 9) mod 12 | [1, 1] |
| 1007 | (n_cs + 9) mod 12 | [1, −1] |

In another example, four SRS symbols can be used for the eight SRS port transmission. In this case, four TD-OCCs and two cyclic shifts can be used to distinguish the eight antenna ports.

The grouping of the eight antenna ports into sets (e.g., which antenna ports can share the same TD-OCC) can be predefined. Additionally or alternatively, the grouping can be configured by higher layer signaling or determined by whether antenna ports share the same phase tracking reference signal (PT-RS) port or not. For instance, the base station can configure the grouping of the eight antenna ports. Or, given that four antenna ports share the same PT-RS port, the UE can determine that these antenna ports can be grouped together.

Referring back to the use of TDM and TD-OCC, a first SRS symbol used for a first set of antenna ports may be dropped due to, for instance, collision handling. In this case, a second SRS symbol used for a second set of antenna ports (or all of such other SRS symbols if more than two SRS symbols are used) may also be dropped based on the first SRS symbol being dropped.

Additionally or alternatively, frequency hopping may be used. If so, the frequency hopping can be performed at a symbol group level, where each symbol group can be used to transmit SRS from all antenna ports.

As also explained herein above, additional maximum cyclic shift can be used for an eight port SRS transmission for some comb values. For instance, n_{SRS}^{cs,max} can be equal to eight, twelve, and sixteen for transmission combs equal to two, four, and eight.

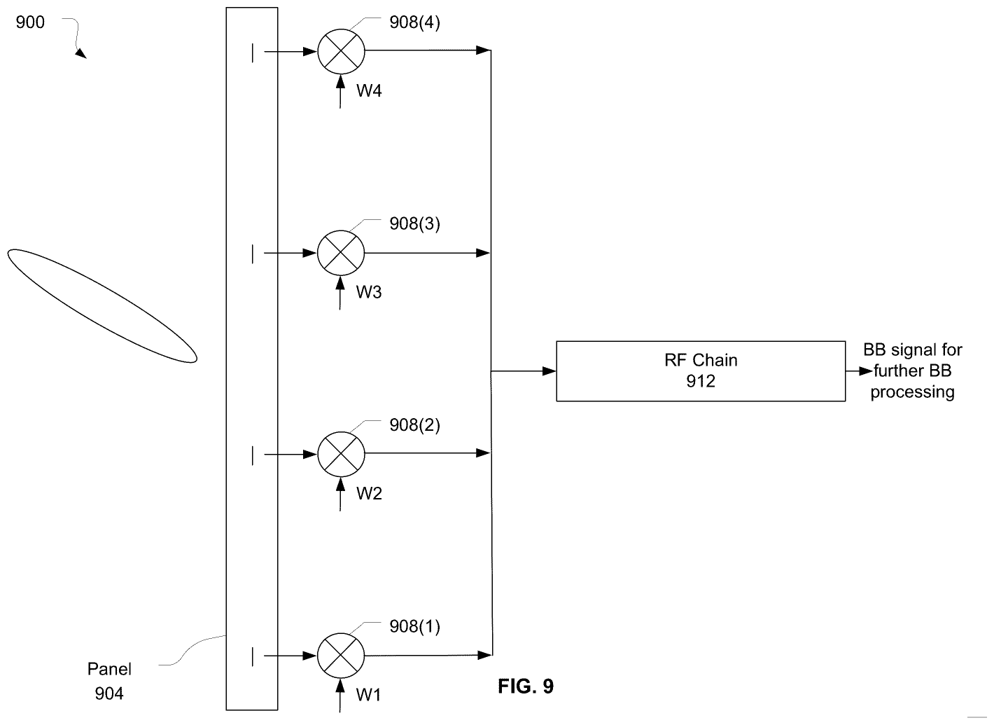

FIG. 9 illustrates receive components 900 of the UE 104, in accordance with some embodiments. The receive components 900 may include an antenna panel 904 that includes a number of antenna elements. The panel 904 is shown with four antenna elements, but other embodiments may include other numbers.

The antenna panel 904 may be coupled to analog beamforming (BF) components that include a number of phase shifters 908(1)-908(4). The phase shifters 908(1)-908(4) may be coupled with a radio-frequency (RF) chain 912. The RF chain 912 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 908(1)-908(4) to provide a receive beam at the antenna panel 904. These BF weights may be determined based on the channel-based beamforming.

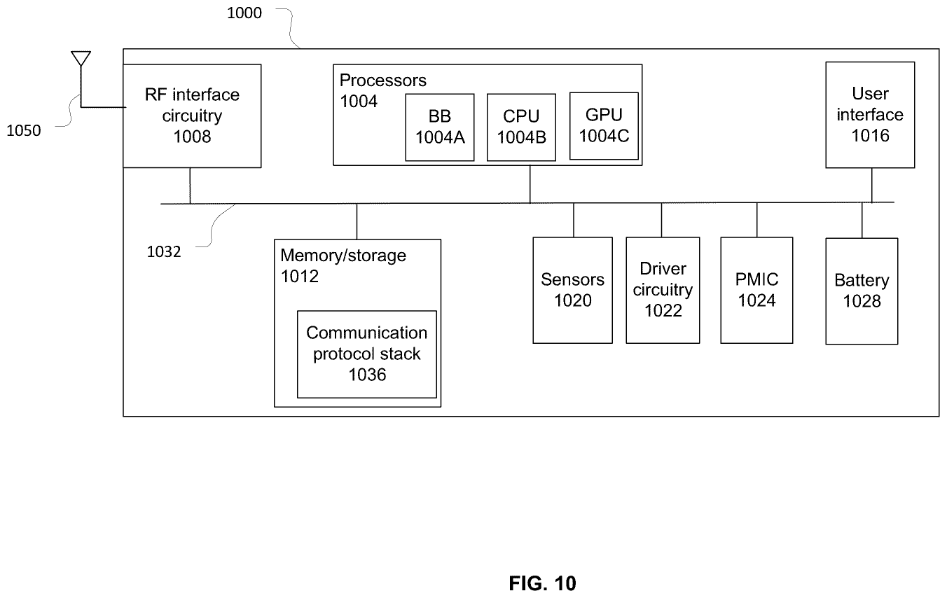

FIG. 10 illustrates a UE 1000, in accordance with some embodiments. The UE 1000 may be similar to and substantially interchangeable with UE 104 of FIG. 1.

Similar to that described above with respect to UE 104, the UE 1000 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1000 may include processors 1004, RF interface circuitry 1008, memory/storage 1012, user interface 1016, sensors 1020, driver circuitry 1022, power management integrated circuit (PMIC) 1024, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangements of the components shown may occur in other implementations.

The components of the UE 1000 may be coupled with various other components over one or more interconnects 1032, which may represent any type of interface, input/output, bus (local, system, or expansion), transmission line, trace, optical connection, etc. that allows various circuit components (on common or different chips or chipsets) to interact with one another.

The processors 1004 may include processor circuitry, such as baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1004A may also access group information from memory/storage 1012 to determine search space groups in which a number of repetitions of a PDCCH may be transmitted.

The memory/storage 1012 may include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1050 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1050.

In various embodiments, the RF interface circuitry 1008 may be configured to transmit/receive signals in a manner compatible with NR access technologies.

The antenna 1050 may include a number of antenna elements that each convert electrical signals into radio waves to travel through the air and to convert received radio waves into electrical signals. The antenna elements may be arranged into one or more antenna panels. The antenna 1050 may have antenna panels that are omnidirectional, directional, or a combination thereof to enable beamforming and multiple input, multiple output communications. The antenna 1050 may include microstrip antennas, printed antennas fabricated on the surface of one or more printed circuit boards, patch antennas, phased array antennas, etc. The antenna 1050 may have one or more panels designed for specific frequency bands including bands in FR1 or FR2.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1000 may power down for brief intervals of time and thus save power. If there is no data traffic activity for an extended period of time, then the UE 1000 may transition off to an RRC_Idle state, where it disconnects from the network and does not perform operations, such as channel quality feedback, handover, etc. The UE 1000 goes into a very low power state and it performs paging where again it periodically wakes up to listen to the network and then powers down again. The UE 1000 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1028 may power the UE 1000, although in some examples the UE 1000 may be mounted deployed in a fixed location and may have a power supply coupled to an electrical grid. The battery 1028 may be a lithium-ion battery, a metal-air battery, such as a zinc-air battery, an aluminum-air battery, a lithium-air battery, and the like. In some implementations, such as in vehicle-based applications, the battery 1028 may be a typical lead-acid automotive battery.

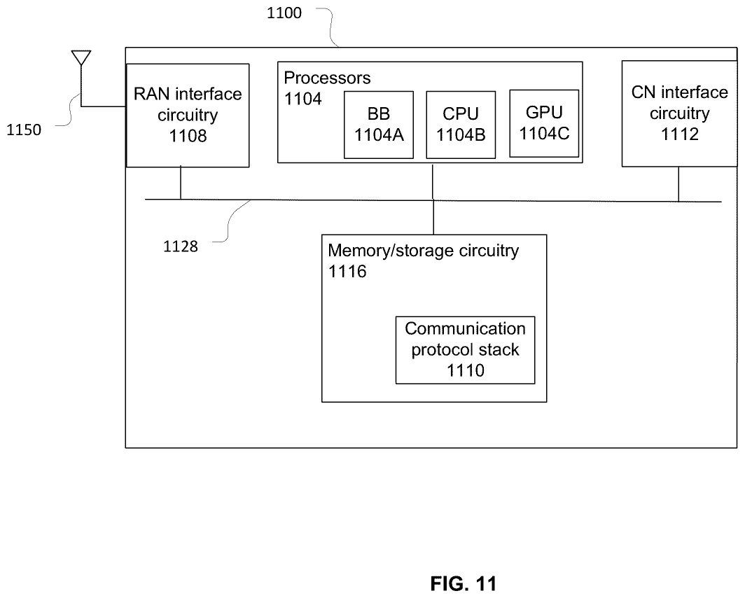

FIG. 11 illustrates a gNB 1100, in accordance with some embodiments. The gNB 1100 may be similar to and substantially interchangeable with the gNB 108 of FIG. 1.

The gNB 1100 may include processors 1104, RAN interface circuitry 1108, core network (CN) interface circuitry 1112, and memory/storage circuitry 1116.

The components of the gNB 1100 may be coupled with various other components over one or more interconnects 1128.

The processors 1104, RAN interface circuitry 1108, memory/storage circuitry 1116 (including communication protocol stack 1110), antenna 1150, and interconnects 1128 may be similar to like-named elements shown and described with respect to FIG. 10.

The CN interface circuitry 1112 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented by a user equipment (UE), the method comprising: receiving, from a base station, configuration information for a codebook-based sounding reference signal (SRS) transmission; determining, based on the configuration information, (i) that at least eight SRS ports are to be used for the codebook-based SRS transmission and (ii) comb information, symbol index information, or cyclic shift information associated with using the at least eight SRS ports; and transmitting an SRS using the at least eight antenna ports based on the comb information and the cyclic shift information.

Example 2 includes a method of example 1, wherein the comb information indicates that only a transmission comb equal to two is allowed for using the at least eight SRS ports.

Example 3 includes a method of any preceding examples, wherein the cyclic shift information indicates a set of maximum number of cyclic shifts for using the at least eight SRS ports, wherein the set includes a first maximum number associated with transmission comb equals to two, a second maximum number associated with transmission comb equals to 4, and a third maximum number associated with transmission comb equals to eight.

Example 4 includes a method of any preceding examples, wherein the comb information indicates that a transmission comb equals to two, four, or eight is allowed, and wherein the method further comprises: determining that frequency division multiplexing (FDM) is to be used for transmitting the SRS using the at least eight SRS ports.

Example 5 includes a method of example 4, wherein the comb information indicates that a first subset of the at least eight SRS ports is associated with a first comb offset and that a second subset of the at least eight SRS ports is associated with a second comb offset, wherein the FDM is based on the first comb offset and the second comb offset.

Example 6 includes a method of example 5, wherein the first comb offset and the second comb offset are associated with a transmission comb equal to four or eight.

Example 7 includes a method of example 4, wherein the comb information indicates that a comb offset for every “N” SRS ports is the same, wherein “N” is equal to two or four.

Example 8 includes a method of example 7, wherein a first comb offset for a first set of “N” SRS ports is configured by radio resource control (RCC) signaling, and wherein a second comb offset for a second set of “N” SRS ports is determined based on a transmission comb value configured by the RRC signaling and on the first comb offset.

Example 9 includes a method of example 8, wherein “N” is equal to two and

wherein the second comb offset is determined further based on an antenna port index.

Example 10 includes a method of any preceding examples, wherein the comb information indicates a comb offset for a subset of the at least eight SRS ports, and wherein the subset is indicated by the base station to the UE or is predefined based on SRS ports of the subset sharing a same phase tracking reference signal port.

Example 11 includes a method of any preceding examples, wherein the comb information indicates that a transmission comb equals to two, four, or eight is allowed, and wherein the method further comprises: determining that time division multiplexing (TDM) is to be used for transmitting the SRS using the at least eight SRS ports.

Example 12 includes a method of example 11, wherein the configuration information indicates that a first subset of the at least eight SRS ports is associated with a symbol index and that a second subset of the at least eight SRS ports is associated with a second symbol index, wherein the TDM is based on the first symbol index and the second symbol index.

Example 13 includes a method of example 12, wherein the first symbol index and the second symbol index are associated with a transmission comb equal to four or eight.

Example 14 includes a method of example 11, wherein the configuration information indicates that a symbol index for every “N” SRS ports is the same, wherein “N” is equal to two or four.

Example 15 includes a method of example 14, wherein a first symbol index for a first set of “N” SRS ports is configured by radio resource control (RCC) signaling.

Example 16 includes a method of example 11, wherein the configuration information indicates a symbol index for a subset of the at least eight SRS ports, and wherein the subset is indicated by the base station to the UE or is predefined based on SRS ports of the subset sharing a same phase tracking reference signal port.

Example 17 includes a method of any preceding examples, wherein the comb information indicates that a transmission comb equals to two, four, or eight is allowed, and wherein the method further comprises: determining that time domain orthogonal cover codes (TD-OCCs) and cyclic shifts are to be used for transmitting the SRS using the at least eight SRS ports.

Example 18 includes a method of example 17, wherein the configuration information indicates that a first subset of the at least eight SRS ports is associated with a first TD-OCC and a first cyclic shift and that a second subset of the at least eight SRS ports is associated with a second TD-OCC and a second cyclic shift.

Example 19 includes a method of example 18, wherein the first TD-OCC, the second TD-OCC, the first cyclic shift, and the second cyclic shift are associated with a transmission comb equal to four or eight.

Example 20 includes a method of example 17, wherein the configuration information indicates that “N” SRS symbols, “N” TD-OCCs, and “8/N” cyclic shifts are to be used, wherein “N” is equal to two or four.

Example 21 includes a method of example 17, wherein the configuration information indicates a TD-OCC is to be used for a subset of the at least eight SRS ports, and wherein the subset is indicated by the base station to the UE or is predefined based on SRS ports of the subset sharing a same phase tracking reference signal port.

Example 22 includes a method of any preceding examples, further comprising: for a second SRS transmission, dropping a first transmission of a first SRS symbol associated with a first SRS port; and dropping, based on the first transmission of the first SRS symbol being dropped, a second transmission of a second SRS symbol associated with a second SRS port.

Example 23 includes a method of any preceding examples, wherein the configuration information indicates that a first group of SRS symbols is associated with a first subset of the at least eight SRS ports, and wherein the method further comprises: determining, based on frequency hopping, a sub-band to be used for the first group of SRS symbols.

Example 24 includes a method of any preceding examples, wherein the configuration information indicates at least one: a first subset of the at least eight SRS ports is associated with a first comb offset and that a second subset of the at least eight SRS ports is associated with a second comb offset for frequency division multiplexing, the first subset is associated with a first symbol index and the second subset is associated with a second symbol index for time division multiplexing, or the first subset is associated with a first time domain orthogonal cover code (TD-OCC) and a first cyclic shift and the second subset is associated with a TD-OCC and a second cyclic shift.

Example 25 includes a method implemented by a base station, the method comprising: sending, to a user equipment (UE), configuration information for a codebook-based sounding reference signal (SRS) transmission, wherein the configuration information is associated with using at least eight SRS ports for the codebook-based SRS transmission, and wherein the configuration information includes comb information, symbol index information, or cyclic shift information associated with using the at least eight SRS ports; and receiving, from the UE, an SRS based on the configuration information.

Example 26 includes a method of example 25, wherein the comb information indicates that a comb offset for every “N” SRS ports is the same, wherein “N” is equal to two or four, and wherein a first comb offset for a first set of “N” SRS ports is configured by radio resource control (RCC) signaling.

Example 27 includes a method of example 25 or 26, wherein the configuration information indicates that a symbol index for every “N” SRS ports is the same, wherein “N” is equal to two or four, and wherein a first symbol index for a first set of “N” SRS ports is configured by radio resource control (RCC) signaling.

Example 28 includes a method of example 25, 26, or 28, wherein the configuration information indicates a time domain orthogonal cover code (TD-OCC) is to be used for a subset of the at least eight SRS ports.

Example 29 includes a UE comprising means to perform one or more elements of a method described in or related to any of the examples 1-24.

Example 30 includes one or more non-transitory computer-readable media comprising instructions to cause a UE, upon execution of the instructions by one or more processors of the UE, to perform one or more elements of a method described in or related to any of the examples 1-24.

Example 31 includes a UE comprising logic, modules, or circuitry to perform one or more elements of a method described in or related to any of the examples 1-24.

Example 32 includes a UE comprising: one or more processors and one or more computer-readable media comprising instructions that, when executed by the one or more processors, cause the one or more processors to perform one or more elements of a method described in or related to any of the examples 1-24.

Example 33 includes a system comprising means to perform one or more elements of a method described in or related to any of the examples 1-24.

Example 34 includes a network comprising means to perform one or more elements of a method described in or related to any of the examples 25-28.

Example 35 includes one or more non-transitory computer-readable media comprising instructions to cause a network, upon execution of the instructions by one or more processors of the network, to perform one or more elements of a method described in or related to any of the examples 25-28.

Example 36 includes a network comprising logic, modules, or circuitry to perform one or more elements of a method described in or related to any of the examples 25-28.

Example 37 includes a network comprising: one or more processors and one or more computer-readable media comprising instructions that, when executed by the one or more processors, cause the one or more processors to perform one or more elements of a method described in or related to any of the examples 25-28.

Example 38 includes a system comprising means to perform one or more elements of a method described in or related to any of the examples 25-28.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus comprising:
processing circuitry to:
process configuration information for a codebook-based sounding reference signal (SRS) transmission, the configuration information received from a base station;
determine, based on the configuration information, (i) that at least eight SRS ports are to be used for the codebook-based SRS transmission and (ii) comb information, symbol index information, or cyclic shift information associated with using the at least eight SRS ports; and
generate an SRS for transmission using the at least eight SRS ports based on the comb information and the cyclic shift information; and
interface circuitry coupled with the processing circuitry to enable communication.

2. The apparatus of claim 1, wherein the comb information indicates that only a transmission comb equals to two is allowed for using the at least eight SRS ports.

3. The apparatus of claim 1, wherein the cyclic shift information indicates a set of maximum number of cyclic shifts for using the at least eight SRS ports, wherein the set includes a first maximum number associated with a transmission comb equals to two, a second maximum number associated with a transmission comb equals to 4, and a third maximum number associated with transmission comb equals to eight.

4. The apparatus of claim 1, wherein the comb information indicates that a transmission comb equals to two, four, or eight is allowed, and wherein the processing circuitry is further configured to:
determine that frequency division multiplexing (FDM) is to be used for transmitting the SRS using the at least eight SRS ports.

5. The apparatus of claim 4, wherein the comb information indicates that a first subset of the at least eight SRS ports is associated with a first comb offset and that a second subset of the at least eight SRS ports is associated with a second comb offset, wherein the FDM is based on the first comb offset and the second comb offset.

6. The apparatus of claim 5, wherein the first comb offset and the second comb offset are associated with the transmission comb equal to four or eight.

7. The apparatus of claim 4, wherein the comb information indicates that a comb offset for every “N” SRS ports is the same, wherein “N” is equal to two or four.

8. The apparatus of claim 7, wherein a first comb offset for a first set of “N” SRS ports is configured by radio resource control (RRC) signaling, and wherein a second comb offset for a second set of “N” SRS ports is determined based on a transmission comb value configured by the RRC signaling and on the first comb offset.

9. The apparatus of claim 8, wherein “N” is equal to two and wherein the second comb offset is determined further based on an antenna port index.

10. The apparatus of claim 4, wherein the comb information indicates a comb offset for a subset of the at least eight SRS ports, and wherein the subset is indicated by the base station or is predefined based on SRS ports of the subset sharing a same phase tracking reference signal port.

11. The apparatus of claim 1, wherein the comb information indicates that a transmission comb equals to two, four, or eight is allowed, and wherein the processing circuitry is further configured to:
determine that time division multiplexing (TDM) is to be used for transmitting the SRS using the at least eight SRS ports.

12. The apparatus of claim 11, wherein the configuration information indicates that a first subset of the at least eight SRS ports is associated with a first symbol index and that a second subset of the at least eight SRS ports is associated with a second symbol index, wherein the TDM is based on the first symbol index and the second symbol index.

13. The apparatus of claim 12, wherein the first symbol index and the second symbol index are associated with the transmission comb equal to four or eight.

14. The apparatus of claim 11, wherein the configuration information indicates that a symbol index for every “N” SRS ports is the same, wherein “N” is equal to two or four.

15. The apparatus of claim 14, wherein a first symbol index for a first set of “N” SRS ports is configured by radio resource control (RRC) signaling.

16. The apparatus of claim 11, wherein the configuration information indicates a symbol index for a subset of the at least eight SRS ports, and wherein the subset is indicated by the base station or is predefined based on SRS ports of the subset sharing a same phase tracking reference signal port.

17. A method implemented by a base station, the method comprising:
generating, for transmission to a user equipment (UE), configuration information for a codebook-based sounding reference signal (SRS) transmission, wherein the configuration information is associated with using at least eight SRS ports for the codebook-based SRS transmission, and wherein the configuration information includes comb information, symbol index information, or cyclic shift information associated with using the at least eight SRS ports; and
receiving, from the UE, an SRS based on the configuration information.

18. The method of claim 17, wherein the comb information indicates that a comb offset for every “N” SRS ports is the same, wherein “N” is equal to two or four, and wherein a first comb offset for a first set of “N” SRS ports is configured by radio resource control (RRC) signaling.

19. One or more computer-readable storage media storing instructions, that upon execution on a user equipment (UE), cause the UE to perform operations comprising:
receiving, from a base station, configuration information for a codebook-based sounding reference signal (SRS) transmission;
determining, based on the configuration information, (i) that at least eight SRS ports are to be used for the codebook-based SRS transmission and (ii) comb information, symbol index information, or cyclic shift information associated with using the at least eight SRS ports; and
generating an SRS for transmission using the at least eight SRS ports based on the comb information and the cyclic shift information.

20. The one or more computer-readable storage media of claim 19, wherein the configuration information indicates at least one:
a first subset of the at least eight SRS ports is associated with a first comb offset and that a second subset of the at least eight SRS ports is associated with a second comb offset for frequency division multiplexing, or
the first subset is associated with a first symbol index and the second subset is associated with a second symbol index for time division multiplexing.
